(19) United States
(12) Patent Application Publication
(10) Pub. No.: US 2011/0094162 A1
(43) Pub. Date: Apr. 28, 2011

(54) PANEL HANGERS FOR SLIDING PANEL TRACK SYSTEMS

(75) Inventors: John E. Morris, Lake Mills, WI (US); Christopher J. Malin, Cross Plains, WI (US)

(73) Assignee: Springs Window Fashions, LLC.

(21) Appl. No.: 12/985,920

(22) Filed: Jan. 6, 2011

Related U.S. Application Data
(62) Division of application No. 12/192,159, filed on Aug. 15, 2008.
(60) Provisional application No. 60/957,837, filed on Aug. 24, 2007.

(51) Int. Cl. E05D 15/06; E06B 3/46

(52) U.S. Cl. 49/409; 16/94 R

(57) ABSTRACT

A sliding panel track system has a headrail with traversing rails therein, the traversing rails having open-ended channels with downwardly facing slots. Panels for the system are attached to hangers, including different hangers for different types of panels. The hangers are readily and easily inserted into and withdrawn from the channels and slots via the open ends thereof.

### CROSS REFERENCE TO RELATED APPLICATIONS

This is a division of U.S. patent application Ser. No. 12/192,159, entitled “PANEL HANGERS FOR SLIDING PANEL TRACK SYSTEMS”, filed Aug. 15, 2008, which claims the benefits of U.S. Provisional Application for Patent Ser. No. 60/957,837, filed Aug. 24, 2007.

### BACKGROUND OF THE INVENTION

1. Field of the Invention

The present invention relates generally to decorative window and door coverings, and, more particularly, to sliding panel systems. Still more specifically, the invention pertains to the sliding structures and the constructions for attaching panels of various types to the track system.

2. Description of the Related Art

Sliding panel track systems are used to cover and decorate architectural openings such as patio doors, large windows and the like. Sliding panels also can be used as room dividers, area separators and the like. In a sliding panel track system, a headrail defining a plurality of tracks is affixed in place to a wall, ceiling or the like, and one or more panels are suspended therefrom. Typically, multiple panels are suspended from the headrail, to traverse along different tracks in the headrail, and thereby to open and close portions of the panel system as desired by overlapping two or more panels to greater and lesser extent. Many different types of panels can be used, including but not limited to soft, shear, lightweight fabrics, heavier fabrics, wood or simulated wood panels of various types, and the like. It is advantageous and desirable to be able to change panels in the track as seasons change, room decorations change, area uses change and the like. Since the panel systems are often quite large, a dramatic impact can be made in the room by changing the panels. Accordingly, it would be desirable to be able to change the panels periodically, rotating or alternating between various different panels; and/or changing the panels as the room décor, use or function changes.

Different techniques and structures have been used for securing the panels to the headrail while allowing the panels to traverse along the headrail. Generally, traversing rails are provided to slide along tracks in a headrail, and panels are attached by various means to the traversing rails. Lightweight fabrics have been attached to the traversing rails with strips of hook-and-loop fastening material. However, hook-and-loop materials do not work well with panels of heavier fabrics and/or other heavy materials and/or panels of longer lengths. Rigid fasteners such as screws have been used together with Velcro to secure panels to the traversing rails, but the assembly thereof can be time consuming, and replacement or change can be difficult. It is known also to form a loop at the upper end of the panel by sewing, gluing, heat sealing or the like. A rigid rod is inserted in the loop, and the loop with rod therein is inserted in the traversing rail. Sliding the looped fabric with a rod therein into a retaining space in the traversing rail can be difficult. According to yet another method, a series of metal grommets and hooks are used to attach the panels to the traversing rail. Oval grommets are installed along the top edge of the panel. Hooks are fixedly positioned along the length of the traversing rail. The panels are then hung on the hooks projecting downward from the traversing rail. Since the hooks are fixedly positioned, the grommets must be accurately positioned along the panel edge to align with the hooks. Installing the grommets into the panel can be time consuming, and attaching the panels to the hooks by capturing each hook in an aligned grommet can be awkward.

Accordingly, a system for interchangeable panels that can be assembled quickly and easily, yet operate smoothly, is desirable. As disclosed herein, a system includes a headrail having channels and traversing rails for sliding along the channels. Two different hanger devices are provided for securing panels of different types to the traversing rails. A first hanger device is particularly suitable for attachment to lightweight panels, and a second hanger device is particularly suitable for attachment to thicker and/or heavier panels. The hanger devices are interchangeable in the traversing rails so that replacement of one panel with another panel can be accomplished quickly.

### SUMMARY OF THE INVENTION

The present sliding panel track system can use different types of hangers for heavy and light panels, both of which can be interchangeably mounted in traversing rails of the sliding system. Change of one for another is easy and simple, facilitating customer customization.

In one aspect of one form thereof, a sliding panel track system is provided with a headrail defining a track and a traversing rail disposed in the track for movement therein. The traversing rail defines a cavity having an elongated slot opening exposed downward. The cavity has a transverse cavity width, and the slot has a transverse slot width less than the cavity width. A panel hanger is at least partly disposed in the cavity and has at least a portion thereof contained in the cavity. The portion contained in the cavity has a width less than the cavity width and greater than the slot width. The hanger is an “L”-shaped body retained in the cavity, the “L”-shaped body having a base segment wider than the slot width. A panel is attached to the hanger.

In another aspect of another form thereof, a sliding panel track system is provided with a headrail defining a plurality of tracks and first and second traversing rails disposed in different tracks. The first and second traversing rails each define an elongated cavity having an elongated slot opening thereto exposed downward. The cavity of each traversing rail has a transverse cavity width, and each slot has a transverse slot width less than the cavity width. Each panel of a plurality of panels is connected to a panel hanger of a plurality of panel hangers for selective insertion into the cavities. At least one of the panel hangers is an “L”-shaped body retained in the cavity, the “L”-shaped body having a base segment wider than the slot width.

In a further aspect of a further form thereof, a sliding panel track system is provided with a headrail defining a plurality of tracks, and first and second traversing rails disposed in different tracks. The first and second traversing rails each define an elongated cavity having an elongated slot opening thereto exposed downward. The cavity of each traversing rail is open on at least one end of the traversing rail and has a transverse cavity width. The slot of each traversing rail is open on the same end as the end opening of the cavity thereof, and has a transverse slot width less than the cavity width. A first hanger type including an “L”-shaped body is provided for attachment to light-weight panels, and a second hanger type is provided for attachment to panels that are heavier than the light-weight panels. Each of the hangers is slidable axially into the cavities of the traversing rails with a panel attached thereto.

In still another aspect of still another form thereof, a panel assembly is provided for a sliding track system having a headrail defining a track and a traversing rail disposed in the track, the traversing rail defining an elongated cavity having an elongated slot opening thereto exposed downward, the cavity being open on at least one end of the traversing rail and having a transverse cavity width, and the slot being open on the same end as the end opening of the cavity, and having a transverse slot width less than the cavity width. The panel assembly includes a panel hanger of an “L”-shape having a base segment wider than the slot width and narrower than the cavity width; and a vertical segment; and a panel attached to the vertical segment.

An advantage of one form of the present invention is providing a customizable sliding panel track system in which the panels are readily changeable.

Another advantage of another form of the present invention is providing a sliding panel track system in which panels can be provided pre-assembled on hangers that are securable in traversing rails of the system in an easy and quick manner.

A further advantage of a further form thereof is providing a sliding panel track system having hangers securable in traversable rails, with the hangers being suited to the material of the panel being suspended therefrom.

### BRIEF DESCRIPTION OF THE DRAWINGS

The above-mentioned and other features and advantages of this invention, and the manner of attaining them, will become more apparent and the invention will be better understood by reference to the following description of embodiments of the invention taken in conjunction with the accompanying drawings, wherein:

FIG. 1 is a perspective view of a sliding panel track system;

FIG. 2 is a fragmentary perspective view of another sliding panel track system;

FIG. 3 is a perspective view of a headrail with three traversing rails in a sliding panel track system;

FIG. 4 is a perspective view of a headrail for the panel track system;

FIG. 5 is an end view of a traversing rail of the system;

FIG. 6 is a fragmentary perspective view of a sliding panel track system with a traversing rail, a first type of hanger and a lightweight panel;

FIG. 7 is a fragmentary perspective view of the panel track system of FIG. 6, but shown from an angle different from that of FIG. 6, to better illustrate the side of the system opposite the side shown in FIG. 6;

FIG. 8 is an end view of the traversing rail, hanger and panel shown in FIGS. 6 and 7;

FIG. 9 is a fragmentary perspective view of a sliding panel track system with a traversing rail, a second type of hanger and a thicker, heavier panel;

FIG. 10 is a fragmentary perspective view of the panel track system shown in FIG. 9, but shown from an angle different from that of FIG. 9, to better illustrate the side of the system opposite the side shown in FIG. 9;

FIG. 11 an end view of the traversing rail, hanger and panel shown in FIGS. 9 and 10;

FIG. 12 is an end view of the panel and hanger shown in FIGS. 9 and 10, but illustrating an arrangement during assembly; and

FIG. 13 is an end view similar to that of FIG. 12, but illustrating a later stage of assembly.

Corresponding reference characters indicate corresponding parts throughout the several views. The exemplifications set out herein illustrate embodiments of the invention and such exemplifications are not to be construed as limiting the scope of the invention in any manner.

### DETAILED DESCRIPTION OF THE INVENTION

Referring now more specifically to the drawings and to FIG. 1 in particular, numeral 20 designates a sliding panel track system. Track system 20 includes a headrail 22 and a plurality of traversing rails 24, three such traversing rails 24a, 24b and 24c being shown in FIG. 1. More or fewer traversing rails can be used in sliding panel track systems. Panels 26 of various types can be used in sliding panel track system 20, with three such panels 26a, 26b, 26c being shown in FIG. 1. Panels 26a, 26b and 26c in the exemplary embodiment of FIG. 1 are made of wooden slats, but can be of various different materials. Further, while the exemplary embodiment shows three panels 26a, 26b, 26c all of the same type, the system also can use panels of different types intermixed one with another.

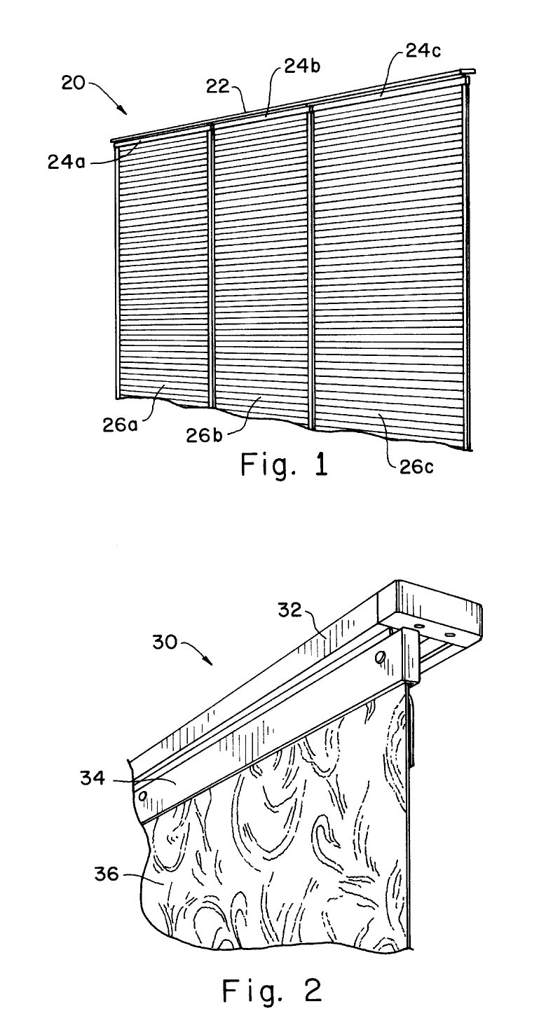

FIG. 2 is a fragmentary portion of another sliding panel track system 30. Track system 30 includes a headrail 32 and a plurality of traversing rails 34, only one of which is visible in FIG. 2. Panels 36 of various types can be used in sliding panel track system 30, one suspended from each traversing rail 34. In the exemplary embodiment of FIG. 2, panel 36 is a lightweight, shear fabric panel.

Panels 26, 36 can be mixed and matched to achieve a desired appearance for systems 20 and 30. For example, panels 26 also can be used in system 30, or panels 36 can be used in system 20. By mixing and matching panels of different colors and types, a variety of different visual appearances can be achieved. The exemplary system disclosed herein facilitates interchangeability of panels of different types.

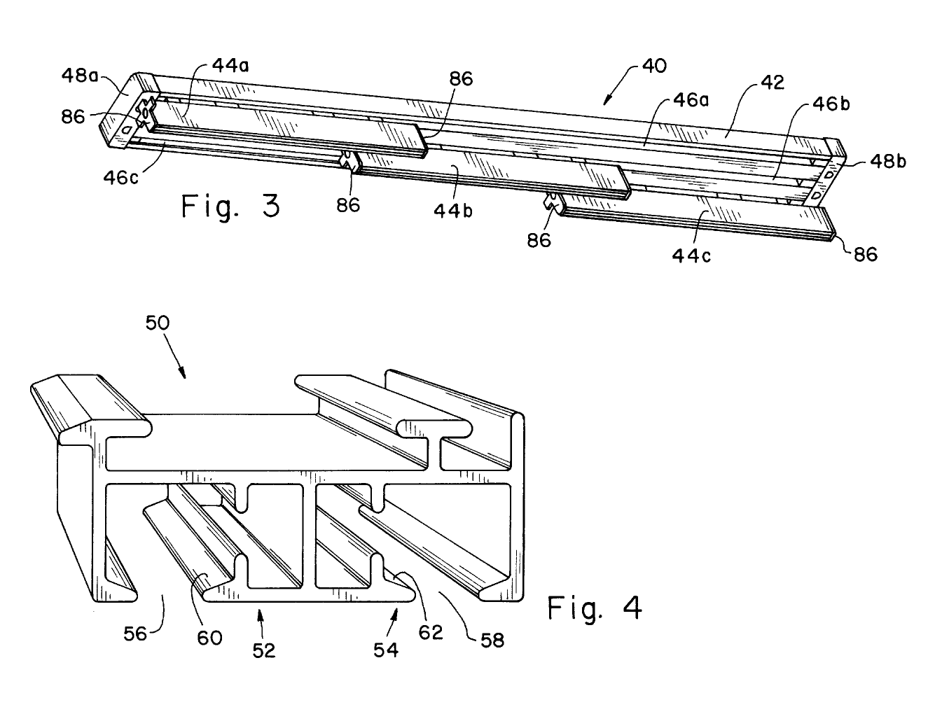

FIG. 3 depicts a sliding panel track system 40 without panels suspended there from. Track system 40 includes a headrail 42 and a plurality of traversing rails 44, three such traversing rails 44a, 44b and 44c being shown in FIG. 3. Headrail 42 defines traversing tracks 46, three such traversing tracks 46a, 46b, 46c being shown in headrail 42. A different traversing rail 44a, 44b, 44c is disposed in each track 46a, 46b, 46c to slide along the track from one end of headrail 42 to the opposite end of headrail 42. It should be understood that each traversing rail 44 need not be disposed in a different track 46, and two or more traversing rails 44 can be operated in a single track 46. End caps 48a, 48b are provided on the opposite ends of headrail 42, closing tracks 46a, 46b, 46c to retain traversing rails 44a, 44b, 44c therein.

Referring now to FIG. 4, a two track headrail 50 is shown. Headrail 50 is an exemplary construction that can be used in the systems described herein; however other construction for sliding track headrails can be used as well. Headrail 50 defines first and second channels 52, 54 for receiving traversing rails therein. Each channel 52, 54 defines an elongate opening 56, 58 along the bottom of headrail 50 and a track 60, 62 along the side of the elongate opening, respectively. It should be understood that headrails can define different numbers of channels and tracks therein, or even one channel, depending on the number of overlying layers of panels that are desired in the final configuration of the sliding panel track system. Various combinations and arrangements of traversing rails within the channels can be used so that desired effects can be achieved with superimposing one panel over another panel in the front and back channels and/or defining openings or spaces between adjacent panels as the positions of traversing rails are adjusted along the lengths of the channels.

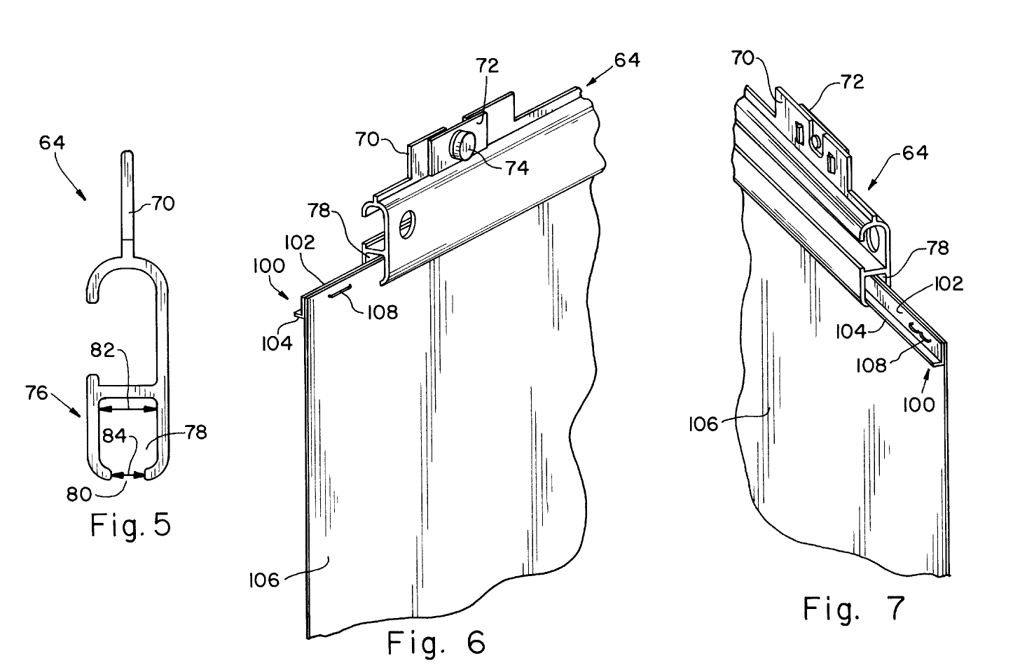

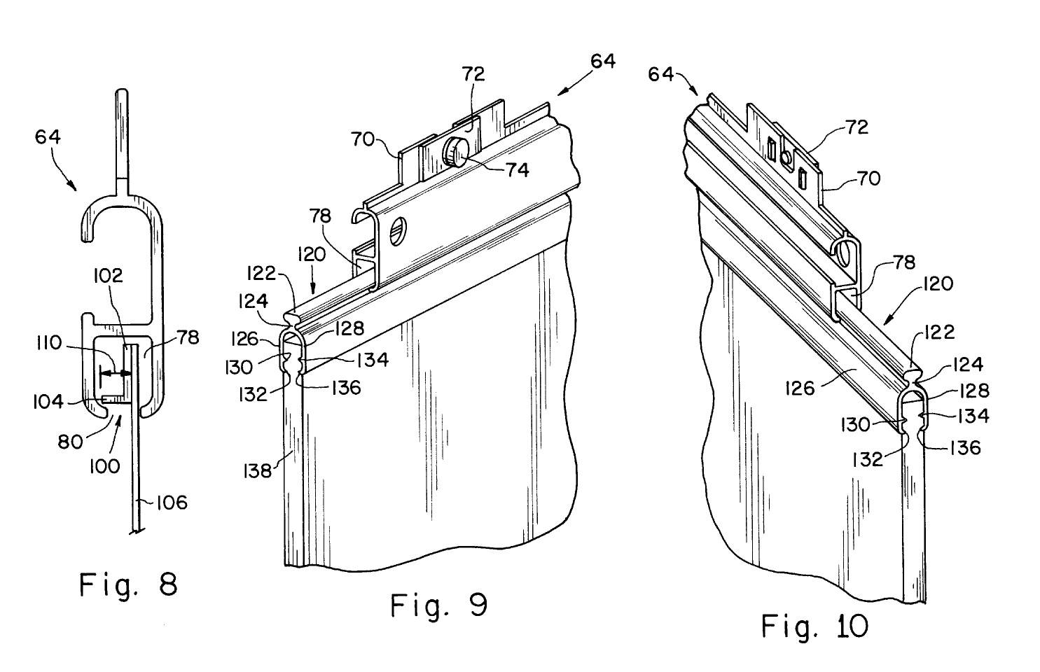

Traversing rails 24, 34, 44 described previously herein are similar in construction, and a single traversing rail 64 is shown and will be described with respect to FIG. 5 through 11. Traversing rail 64 includes connecting fixture 70 connected to carriages 72 that include rollers 74 for traveling along the tracks of the headrail, such as tracks 60, 62 in headrail 50. Connecting fixtures 70 extend through openings 56 or 58 when the traversing rail is installed in the headrail. A receiver 76 is defined at the lower edge of traversing rail 64 and defines an elongate cavity 78 with a slot opening 80 at the bottom thereof. Hangers to be described more fully hereinafter are interchangeably received in cavity 78, the hangers being slid axially into cavity 78 from an end thereof. Cavity 78 has a cavity width indicated by the dimension arrow identified with numeral 82, and slot opening 80 has a slot width indicated by the dimension arrow identified with numeral 84. Slot width 84 is less than cavity width 82, so that the panel hangers are retained in cavity 78 without falling through slot opening 80. End caps 86 (FIG. 3) are provided at opposite ends of the traversing rails to prevent the hangers from sliding out either of the ends unintentionally.

As disclosed herein, panel assemblies include panel hangers of different types for different panels to be suspended from the traversing rails. The panel hangers are interchangeably held in the traversing rails so that a panel secured to one type of panel hanger can be removed and a panel secured to a different type of panel hanger can be substituted for it. Two panel hangers 100 and 120 will be described with respect to FIGS. 6-8 and FIGS. 9-13, respectively.

A first panel hanger 100 shown in FIGS. 6, 7 and 8 is particularly suited for use with a lighter weight fabric panel, such as, for example, panel 36 described previously. First panel hanger 100 is an L-shaped body in transverse cross-section, having a length to extend across the width of a panel to which it is attached. Hanger 100 includes a vertical segment 102 and a horizontal or base segment 104 as installed in traversing rail 64. Attachment of a panel 106 to panel hanger 100 can be by, for example and not limitation, adhesive, ultrasonic welding, hook-and-loop patches, stapling or the like, and may include combinations of fastening techniques. A staple 108 is shown in FIGS. 6 and 7 connecting panel 106 to vertical segment 102, and it should be understood that when staples are used, a plurality of staples may be used. Panel hanger 100 can be made of plastic, such as, for example, PVC in an extrusion molding process, and is relatively inexpensive to manufacture and supply. A transverse width of L-shaped hanger 100, designated by the dimension arrow identified with numeral 110, is narrower than cavity width 82, but wider than slot opening width 84 such that hanger 100 can not fall through slot opening 80.

In the exemplary embodiment shown, hanger 100 is fully contained within cavity 78, and the fastened edge of panel 106 including staple 108 is thereby concealed in traversing rail 64. However, in an installation in which exposing the upper edge of the panel, including any fasteners such as staples 108, is not of concern, hanger 100 can be used in an opposite orientation, with vertical segment 102 depending downwardly from horizontal segment 104, and perhaps even extending through slot opening 80.

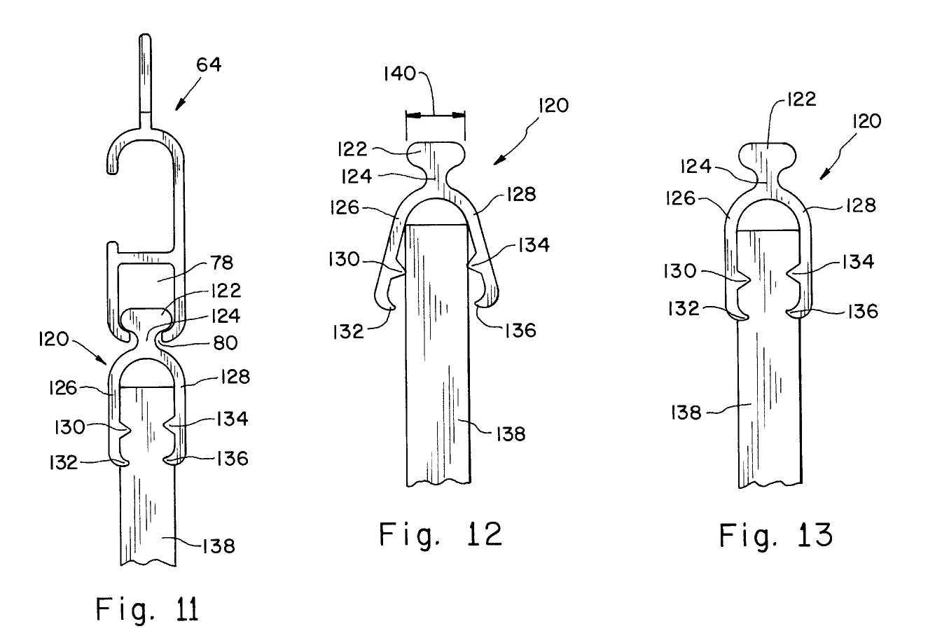

A second panel hanger 120 defines a clamping body that is suitable for use with thicker, heavier panels including heavy fabrics, wood and faux wood or other natural materials, etc., such as panel 26 described previously herein. Panel hanger 120 includes a head 122 and a neck 124 each extending the length of hanger 120, with first and second arms 126, 128 depending from neck 124. First and second arms 126, 128 also extend the length of hanger 120. Arm 126 includes pointed ribs 130, 132; and arm 128 includes pointed ribs 134, 136 on the inwardly facing, opposed surfaces thereof. In the exemplary embodiment, arms 126, 128 are provided with two ribs each; however, it should be understood that more or fewer ribs can be used, and for holding some panels ribs may not be necessary. Panel hanger 120 is constructed of aluminum or other deformable material such that arms 126, 128 can be separated from each sufficiently to receive a panel 138 between ribs of opposed arms 126, 128 (FIG. 12), and then compressed against the panel to cause ribs 130, 132, 134, 136 to engage with or embed into the panel (FIG. 13). Accordingly, the panel is held securely therein. The width of head 122, indicated by the dimension arrow designated with reference number 140, is wider than the width of slot opening 80 such that head 122 can not fall through slot opening 80.

Since hangers 100, 120 are interchangeably received in traversing rail 64, different panels in various combinations and arrangements can be provided; and/or all panels of the same type can be used but periodically changed by removing the panels with hangers attached thereto from the traversing rails through an end of the traversing rails, and thereafter inserting a different panel with hanger attached. A variety of different panels can be provided with traversing rails affixed thereto in efficient, economical constructions so that changing panels can be preformed quickly and easily without having to detach panels from a hanger being used and attaching a new or different panel to the hanger. By use of the present panel hangers disclosed herein each panel can be provided with an individual hanger at minimal cost and expense, and easily inserted into the traversing rail when desired.

Hangers 100, 120 described herein are exemplary in nature, and it should be understood that still other types of inexpensive but secure hangers can be used so that panels attached to hangers can be supplied cost effectively. For example, a generally T-shape hanger can be used, the hanger being of plastic or other material and having an enlarged formation such as head 122 retained in the traversing rail and a thinner plate similar to vertical segment 102 extending downwardly from the traversing rail through the open slot thereof. A panel can be secured to the plate by adhesive, ultrasonic welding, hook-and-loop patches, physical fasteners such as staples, combinations of such fastening techniques and the like.

Variations and modifications of the foregoing are within the scope of the present invention. It is understood that the invention disclosed and defined herein extends to all alternative combinations of two or more of the individual features mentioned or evident from the text and/or drawings. All of these different combinations constitute various alternative aspects of the present invention. The embodiments described herein explain the best modes known for practicing the invention and will enable others skilled in the art to utilize the invention. The claims are to be construed to include alternative embodiments to the extent permitted by the prior art.

While this invention has been described with respect to at least one embodiment, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

What is claimed is:

1. A sliding panel track system, comprising:
a headrail defining a first track;
a first traversing rail disposed in said first track for movement therein, said first traversing rail defining a first cavity having a first elongated slot opening exposed downward, said first cavity having a transverse first cavity width, and said first slot having a transverse first slot width less than said first cavity width;
a first panel hanger at least partly disposed in said first cavity and having at least a portion thereof contained in said first cavity, said portion having a width less than said first cavity width and greater than said first slot width, said first panel hanger being an “L”-shaped body retained in said first cavity, said “L”-shaped body having a base segment wider than said first slot width; and
a first panel attached to said first panel hanger.

2. The sliding panel track system of claim 1, further comprising:
said headrail defining a second track;
a second traversing rail disposed in said second track for movement therein, said second traversing rail defining a second cavity having a second elongated slot opening exposed downward, said second cavity having a transverse second cavity width, and said second slot having a transverse second slot width less than said second cavity width;
a second panel hanger at least partly disposed in said second cavity and having at least a portion thereof contained in said second cavity, said portion of said second panel hanger having a width less than said second cavity width and greater than said second slot width; and
a second panel attached to said second panel hanger.

3. The sliding panel track system of claim 2, said second panel hanger being a said “L”-shaped body.

4. The sliding panel track system of claim 2, said second panel hanger being a clamping body having a head disposed in said second cavity and wider than said second slot width, a neck extending from said head through said second slot, and opposed arms outwardly of said second cavity, said opposed arms being deformable toward each other.

5. The sliding panel track system of claim 2, including a third traversing rail disposed in one of said tracks; a third panel hanger held in said third traversing rail, and a third panel attached to said third panel hanger.

6. The sliding panel track system of claim 5, said second and third panel hangers each being a said “L”-shaped body, and said first second and third panels being attached to said L-shaped bodies by staples.

7. A sliding panel track system, comprising:
a headrail defining a plurality of tracks;
first and second traversing rails disposed in different tracks of said plurality of tracks, said first and second traversing rails each defining an elongated cavity having an elongated slot opening thereto exposed downward, said cavity of each traversing rail having a transverse cavity width and each said slot having a transverse slot width less than said cavity width;
a plurality of panels each panel of which is connected to a panel hanger of a plurality of panel hangers for selective insertion into said cavities; and
at least one of said panel hangers being an “L”-shaped body retained in said cavity, said “L”-shaped body having a base segment wider than said slot width.

8. The sliding panel track system of claim 7, at least one of said panels being secured to a said “L”-shaped body by at least one staple.

9. The sliding panel track system of claim 7, less than all of said hangers being L-shaped bodies.

10. A sliding panel track system, comprising:
a headrail defining a plurality of tracks;
first and second traversing rails disposed in different tracks of said plurality of tracks, said first and second traversing rails each defining an elongated cavity having an elongated slot opening thereto exposed downward, said cavity of each traversing rail being open on at least one end of the traversing rail and having a transverse cavity width, and said slot of each said traversing rail being open on the same end as the end opening of said cavity thereof, and having a transverse slot width less than said cavity width;
a first hanger type including an L-shaped body for attachment to light-weight panels;
a second hanger type for attachment to panels that are heavier than said light-weight panels; and
each of said hangers being slidable axially into said cavities with a panel attached thereto.

11. The sliding panel track system of claim 10, including a panel attached by staples to said first hanger type.

12. The sliding panel track system of claim 10, said second hanger type being a clamping body having a head disposed in said cavity and wider than said slot width, a neck extending from said head through said slot, and opposed arms outwardly of said cavity, said opposed arms being deformable toward each other for clamping a panel therebetween.

13. A panel assembly for a sliding track system having a headrail defining a track and a traversing rail disposed in the track, the traversing rail defining an elongated cavity having an elongated slot opening thereto exposed downward, the cavity being open on at least one end of the traversing rail and having a transverse cavity width, and the slot being open on the same end as the end opening of the cavity, and having a transverse slot width less than the cavity width, said panel assembly comprising:
a panel hanger of an “L”-shape having a base segment wider than the slot width and narrower than the cavity width; and a vertical segment; and
a panel attached to said vertical segment;
said panel assembly slidable axially into the traversing rail open end.

14. The panel assembly of claim 13, including a staple connecting said panel to said vertical segment
